(19) United States
(12) Patent Application Publication
(10) Pub. No.: US 2018/0183046 A1
(43) Pub. Date: Jun. 28, 2018

(54) POSITIVE ELECTRODE ACTIVE MATERIAL FOR LITHIUM SECONDARY BATTERY, METHOD FOR PREPARING THE SAME, AND LITHIUM SECONDARY BATTERY INCLUDING THE SAME

(71) Applicant: LG Chem, Ltd., Seoul (KR)

(72) Inventors: Joo Hong Jin, Daejeon (KR); Ju Kyung Shin, Daejeon (KR); In Seong Ju, Daejeon (KR); Wang Mo Jung, Daejeon (KR); Byung Chun Park, Daejeon (KR)

(73) Assignee: LG Chem, Ltd., Seoul (KR)

(21) Appl. No.: 15/855,127

(22) Filed: Dec. 27, 2017

(30) Foreign Application Priority Data
Dec. 28, 2016 (KR) 10-2016-0181023
Dec. 28, 2016 (KR) 10-2016-0181024
Dec. 27, 2017 (KR) 10-2017-0180858

(51) Int. Cl. H01M 4/1315; H01M 10/0525; H01M 4/505; H01M 4/525; H01M 4/58; C01B 25/45

(52) U.S. Cl. CPC H01M 4/1315; H01M 10/0525; H01M 4/505; H01M 2004/021; H01M 4/5825; C01B 25/45; H01M 4/525

(57) ABSTRACT

Provided are a positive electrode active material having a concentration gradient in which concentrations of nickel and manganese are gradually changed from a center of a particle to a surface thereof, and a peak appears at 235° C. or more when heat flow of the positive electrode active material is measured by differential scanning calorimetry, a method of preparing the positive electrode active material, and a lithium secondary battery including the positive electrode active material.

### TECHNICAL FIELD

The present invention relates to a positive electrode active material for a lithium secondary battery, a method of preparing the same, and a lithium secondary battery including the positive electrode active material.

### BACKGROUND ART

Demand for secondary batteries as an energy source has been significantly increased as technology development and demand with respect to mobile devices have increased. Among these secondary batteries, lithium secondary batteries having high energy density, high voltage, long cycle life, and low self-discharging rate have been commercialized and widely used.

Lithium transition metal composite oxides have been used as a positive electrode active material of the lithium secondary battery, and, among these oxides, a lithium cobalt composite oxide of LiCoO₂ having a high operating voltage and excellent capacity characteristics has been mainly used. However, LiCoO₂ has very poor thermal properties due to an unstable crystal structure caused by lithium deintercalation. Also, since LiCoO₂ is expensive, there is a limitation in using a large amount of LiCoO₂ as a power source for applications such as electric vehicles.

As a positive electrode active material alternative to LiCoO₂, various lithium transition metal oxides, such as LiNiO₂, LiMnO₂, LiMn₂O₄, or LiFePO₄, have been developed. Among these oxides, with respect to LiNiO₂, it is advantageous in that LiNiO₂ exhibits battery characteristics of high discharge capacity, but the synthesis of the LiNiO₂ may be difficult by a simple solid phase reaction, and thermal stability and cycle characteristics may be low. A lithium manganese-based oxide, such as LiMnO₂ or LiMn₂O₄, is advantageous in that its thermal stability is excellent and the price is low, but the lithium manganese-based oxide may have low capacity and poor high-temperature characteristics. Particularly, with respect to LiMn₂O₄, some have been commercialized as low-cost products, but structural distortion (Jahn-Teller distortion) caused by Mn³⁺ occurs during charge and discharge, and, accordingly, life characteristics degrade. Furthermore, since LiFePO₄ is inexpensive and has excellent stability, a significant amount of research has currently been conducted for the application of LiFePO₄ for a hybrid electric vehicle (HEV), but the application to other areas may be difficult due to low conductivity.

Thus, a lithium nickel manganese cobalt oxide, Li(NiₐCo_{b}Mn_{c})O₂ (where, a, b, and c each independently are an atomic fraction of oxide composition elements, wherein 0<a<1, 0<b<1, 0<c<1, and a+b+c=1), is a material which is currently very much in the spotlight as a positive electrode active material alternative to LiCoO₂. This material is less expensive than LiCoO₂ and may be used in high voltage and high capacity applications, but has limitations in that rate capability and life characteristics at high temperature may be poor.

A lithium secondary battery using the above-described positive electrode active material has limitations in that safety and life characteristics of the battery are rapidly reduced due to an increase in interfacial resistance between an electrolyte and an electrode including the active material as charge and discharge are repeated, decomposition of the electrolyte caused by moisture in the battery or other influences, degradation of a surface structure of the active material, and an exothermic reaction accompanied by rapid structural collapse, and these limitations are more serious under high-temperature and high-voltage conditions.

In order to address these limitations, various methods of improving structural stability and surface stability of the active material itself by doping or performing a surface treatment on the positive electrode active material, and increasing interfacial stability between the electrolyte and the active material have been proposed, but it is not fully satisfactory in terms of their effects and processes.

Furthermore, since the demand for high capacity batteries has recently been increased, there is a growing need for the development of a positive electrode active material which may improve safety and life characteristics of the battery by securing the internal structure and surface stability of active material particles.

### PRIOR ART DOCUMENTS

### Patent Documents

(Patent Document 1) Japanese Patent Application Laid-open Publication No. 2009-140787 (publication 2009 Jun. 25)

### DISCLOSURE OF THE INVENTION

### Technical Problem

To overcome the above-mentioned problems, an aspect of the present invention provides a positive electrode active material for a lithium secondary battery which may improve output characteristics, life characteristics, and thermal stability.

Another aspect of the present invention provides a method of preparing the positive electrode active material having improved output characteristics, life characteristics, and thermal stability.

Another aspect of the present invention provides a positive electrode and a lithium secondary battery which include the positive electrode active material.

### Technical Solution

According to an aspect of the present invention, there is provided a positive electrode active material having a concentration gradient in which concentrations of nickel and manganese are gradually changed from a center of a particle to a surface thereof, wherein the positive electrode active material includes a center portion including a first lithium composite metal oxide having an average composition represented by Formula 1, and a surface portion including a second lithium composite metal oxide having an average composition represented by Formula 2, and a peak appears at 235° C. or more when heat flow of the positive electrode active material is measured by differential scanning calorimetry:

Li₁₊ₓ₁(Niₐ₁Mn_{b1}Co_{1-a1-b1-c1}Me_{c1})O_{2-y1}A_{y1} [Formula 1]

Li₁₊ₓ₂(Niₐ₂Mn_{b2}Co_{1-a2-b2-c2}Me_{c2})O_{2-y2}A_{y2} [Formula 2]

wherein, in Formula 1 and 2, Me is at least one doping element selected from the group consisting of tungsten (W), copper (Cu), iron (Fe), vanadium (V), chromium (Cr), titanium (Ti), zirconium (Zr), zinc (Zn), aluminum (Al), indium (In), tantalum (Ta), yttrium (Y), lanthanum (La), strontium (Sr), gallium (Ga), scandium (Sc), gadolinium (Gd), samarium (Sm), calcium (Ca), cerium (Ce), niobium (Nb), magnesium (Mg), boron (B), and molybdenum (Mo), A is at least one anion selected from the group consisting of PO₄³⁻, NO₄⁻, CO₃²⁻, BO₃⁻, Cl⁻, Br⁻, I⁻, and F⁻, 0.8≤a1<1, 0<b1<0.2, 0<c1≤0.1, 0.8<a1+b1+c1<1, 0≤x1≤0.1, 0.0001<y1≤0.1, 0.1≤a2<0.8, 0.1<b2<0.9, 0<c2≤0.1, 0.2<a2+b2+c2<1, 0≤x2≤0.1, and 0.0001<y2≤0.1.

According to another aspect of the present invention, there is provided a method of preparing a positive electrode active material which includes: preparing a first metal-containing solution including nickel, cobalt, manganese, and doping element Me (where Me includes at least one selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo) and a second metal-containing solution including nickel, cobalt, manganese, and doping element Me in concentrations different from those in the first metal-containing solution; preparing a positive electrode active material precursor having a concentration gradient, in which concentrations of the nickel and the manganese each independently are gradually changed from a center of a particle to a surface thereof, by mixing the first metal-containing solution and the second metal-containing solution such that a mixing ratio of the first metal-containing solution and the second metal-containing solution is gradually changed from 100 vol %:0 vol % to 0 vol %:100 vol % and adding an ammonium cationic complexing agent and an anion-containing basic compound; synthesizing a positive electrode active material by mixing and sintering the positive electrode active material precursor and a lithium-containing raw material; and performing a heat treatment on the positive electrode active material at a temperature of 600° C. to 800° C. in an oxygen atmosphere.

According to another aspect of the present invention, there is provided a positive electrode for a lithium secondary battery including the positive electrode active material and a lithium secondary battery including the positive electrode.

### Advantageous Effects

Since a positive electrode active material according to the present invention has a concentration gradient in which concentrations of nickel and manganese are gradually changed from the center of a particle to the surface thereof, the positive electrode active material having increased structural stability and thermal stability may be prepared. Particularly, since the positive electrode active material including a center portion with a high nickel content and a surface portion with a low nickel content is provided, a secondary battery having excellent capacity and improved output characteristics may be prepared when the positive electrode active material is used in the secondary battery.

Also, since a metal site of a lithium composite metal oxide is doped with a doping element (Me), the positive electrode active material of the present invention may further improve the output characteristics of the battery in which the positive electrode active material is used. In addition, since desorption of oxygen during charge and discharge of the lithium secondary battery may be prevented by substituting anions at a portion of oxygen sites of the lithium composite metal oxide, a lithium secondary battery having high capacity and excellent life characteristics may be provided.

### BRIEF DESCRIPTION OF THE DRAWINGS

FIG. 1 is a graph illustrating heat flows according to the temperature of positive electrode active materials prepared in Examples 1 and 2 and Comparative Examples 2 and 3 of the present invention;

FIGS. 2A and 2B are scanning electron microscope (SEM) images of the positive electrode active materials prepared respectively in Example 2 and Comparative Example 2 of the present invention;

FIG. 3 is a graph illustrating life characteristics at 4.25 V according to cycles of lithium secondary batteries prepared in Example 2 and Comparative Example 1 of the present invention;

FIG. 4 is a comparison graph illustrating life characteristics and resistance increase rates according to cycles of lithium secondary batteries prepared in Example 1 and Comparative Example 3 of the present invention;

FIG. 5 is a graph illustrating resistance characteristics depending on a state of charge (SOC) of Example 2 and Comparative Example 2 of the present invention; and

FIG. 6 is a graph illustrating life characteristics at 4.5 V according to cycles of the lithium secondary batteries prepared in Example 1 and Comparative Example 2 of the present invention.

### MODE FOR CARRYING OUT THE INVENTION

Hereinafter, the present invention will be described in more detail.

It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

Typically, with respect to a positive electrode active material, cracks and collapse of active material particles easily occur in coating and rolling processes during the preparation of a battery, and cracks of the active material particles also occur during charge and discharge of the battery to degrade life characteristics. Also, if a nickel content in a positive electrode active material having constant internal/external compositions is increased, positive electrode degradation occurs at a surface due to a side reaction at the surface. With respect to a positive electrode active material having a concentration gradient in which an amount of a metallic element in an active material particle is gradually changed, since a nickel content of a center portion is structurally higher than that of a surface or an average composition, there is a limitation in that internal stability is significantly reduced when cracks of the positive electrode active material particles occur.

In order to address this limitation, the present invention provides a concentration gradient type positive electrode active material in which excellent structural stability is obtained by gradually changing an amount of metal in a positive electrode active material particle, wherein output characteristics may be improved by including a large amount of nickel having high capacity characteristics in a center portion of the positive electrode active material and including a relatively smaller amount of nickel in a surface portion, but by doping a portion of the metal in the positive electrode active material with a highly stable doping element, and desorption of oxygen during charge and discharge may be prevented by substituting anions at oxygen sites in the positive electrode active material.

Specifically, a positive electrode active material according to an embodiment of the present invention has a concentration gradient in which concentrations of nickel and manganese are gradually changed from a center of a particle to a surface thereof, wherein the positive electrode active material includes a center portion including a first lithium composite metal oxide having an average composition represented by the following Formula 1; and a surface portion including a second lithium composite metal oxide having an average composition represented by the following Formula 2, and a peak appears at 235° C. or more when heat flow of the positive electrode active material is measured by differential scanning calorimetry:

Li₁₊ₓ₁(Niₐ₁Mn_{b1}Co_{1-a1-b1-c1}Me_{c1})O_{2-y1}A_{y1} [Formula 1]

Li₁₊ₓ₂(Niₐ₂Mn_{b2}Co_{1-a2-b2-c2}Me_{c2})O_{2-y2}A_{y2} [Formula 2]

in Formula 1 and 2, Me is at least one doping element selected from the group consisting of tungsten (W), copper (Cu), iron (Fe), vanadium (V), chromium (Cr), titanium (Ti), zirconium (Zr), zinc (Zn), aluminum (Al), indium (In), tantalum (Ta), yttrium (Y), lanthanum (La), strontium (Sr), gallium (Ga), scandium (Sc), gadolinium (Gd), samarium (Sm), calcium (Ca), cerium (Ce), niobium (Nb), magnesium (Mg), boron (B), and molybdenum (Mo), A is at least one anion selected from the group consisting of PO₄³⁻, NO₄⁻, CO₃²⁻, BO₃⁻, Cl⁻, Br⁻, I⁻, and F⁻, 0.8≤a1<1, 0<b1<0.2, 0<c1≤0.1, 0.8<a1+b1+c1<1, 0≤x1≤0.1, 0.0001<y1≤0.1, 0.1≤a2<0.8, 0.1<b2<0.9, 0<c2≤0.1, 0.2<a2+b2+c2<1, 0≤x2≤0.1, and 0.0001<y2≤0.1.

The nickel and manganese included in the positive electrode active material may each independently be increased or decreased while having a concentration gradient in which the concentration is gradually changed from the center of the positive electrode active material particle to the surface thereof. In this case, a concentration gradient slope of each metallic element may be constant.

Nickel, cobalt, and manganese included in the positive electrode active material may each independently have a single concentration gradient slope.

Specifically, the concentration of the nickel included in the positive electrode active material may be decreased while the nickel has a concentration gradient gradually changing from the center of the positive electrode active material particle to the surface thereof, and, in this case, the concentration gradient slope of the nickel may be constant from the center of the positive electrode active material particle to the surface thereof. In a case in which the nickel has a concentration gradient in which a high concentration of the nickel is maintained at the center of the active material particle and the concentration is decreased from the center of the particle to the surface thereof, a decrease in capacity may be prevented while thermal stability is exhibited.

Also, the concentration of the manganese included in the positive electrode active material may be increased while the manganese has a concentration gradient gradually changing from the center of the active material particle to the surface thereof, and, in this case, the concentration gradient slope of the manganese may be constant from the center of the positive electrode active material particle to the surface thereof. In a case in which the manganese has a concentration gradient in which a low concentration of the manganese is maintained at the center of the active material particle and the concentration is increased from the center of the particle to the surface thereof, excellent thermal stability may be obtained without a decrease in capacity.

Furthermore, the concentration of the cobalt included in the positive electrode active material may be constantly maintained from the center of the active material particle to the surface thereof by diffusion of the cobalt during the synthesis of the positive electrode active material.

In the present invention, the expression “metal has a gradually changing concentration gradient” denotes that the metal has a concentration distribution in which the concentration of the metal is continuously and stepwise changed over the entire particle or in a specific area. Specifically, in the concentration distribution, the metal concentration per 1 μm in the particle toward the surface may have a difference of 0.1 at % to 30 at %, for example, 0.1 at % to 20 at %, based on a total atomic weight of the corresponding metal included in the active material particle.

Since the positive electrode active material according to the embodiment of the present invention has a concentration gradient, in which the concentration of the metal is gradually changed depending on the position in the positive electrode active material particle, as described above, an abrupt phase boundary region is not present from the center to the surface, and thus, its crystal structure is stabilized and thermal stability is increased. Also, in a case in which the concentration gradient slope of the metal is constant, the effect of improvement in the structural stability may be further improved, and, since the concentration of each metal in the active material particle is changed by the concentration gradient, the effect of the positive electrode active material on the improvement of the battery performance may be further improved by easily using properties of the corresponding metal.

Thus, since the positive electrode active material for a lithium secondary battery according to the embodiment of the present invention includes lithium composite metal oxide particles having a concentration gradient in which the concentrations of nickel and manganese are gradually changed from the center of the particle to the surface thereof, high capacity, long lifetime, and thermal stability may be obtained and, simultaneously, performance degradation at high voltage may be minimized when used in the secondary battery.

Specifically, the center portion includes the first lithium composite metal oxide having an average composition represented by Formula 1.

The center portion may include nickel in an amount of 80 mol % or more to less than 100 mol %, for example, 90 mol % or more to less than 100 mol %, based on total moles of metallic elements except lithium which are included in the entire center portion. In a case in which the amount of the nickel is less than 80 mol %, since the capacity of the positive electrode active material is reduced, the positive electrode active material may not be used in an electrochemical device requiring high capacity.

The center portion may include manganese in an amount of greater than 0 mol % to less than 20 mol %, for example, greater than 0 mol % to 5 mol % or less, based on the total moles of the metallic elements except lithium which are included in the entire center portion. In a case in which the amount of the manganese is 20 mol % or more, there is a limitation in obtaining high capacity.

In addition, the amount of cobalt included in the center portion may vary depending on the amounts of the nickel, manganese and Me. In a case in which the amount of the cobalt is excessively large, raw material costs may overall increase due to the high cobalt content, and reversible capacity may be somewhat reduced. In a case in which the amount of the cobalt is excessively small, it may be difficult to achieve sufficient rate capability and high powder density of the battery at the same time. The cobalt included in the center portion may be included in an amount of greater than 0 mol % to less than 20 mol %, for example, 5 mol % or more to 10 mol % or less, based on total moles of the metallic elements which are included in the entire center portion.

The surface portion includes the second lithium composite metal oxide having an average composition represented by Formula 2.

The surface portion may include nickel in an amount of 10 mol % or more to less than 80 mol %, for example, 60 mol % or more to less than 80 mol %, based on total moles of metallic elements except lithium which are included in the entire surface portion. In a case in which the amount of the nickel is less than 10 mol %, average capacity of the positive electrode active material may be reduced, and, in a case in which the amount of the nickel is 80 mol % or more, stability of the positive electrode active material may be reduced because stability required in the surface portion is not satisfied.

The surface portion may include manganese in an amount of greater than 10 mol % to less than 90 mol %, for example, 10 mol % or more to 20 mol % or less, based on the total moles of the metallic elements except lithium which are included in the entire surface portion. In a case in which the amount of the manganese is greater than 90 mol %, there is a limitation in obtaining high capacity.

In addition, the amount of cobalt included in the surface portion may vary depending on the amounts of the nickel, manganese and Me, and may be constantly maintained over the entire center portion and surface portion. The cobalt included in the surface portion may be included in an amount of greater than 0 mol % to less than 20 mol %, for example, 5 mol % or more to 15 mol % or less, based on total moles of the metallic elements which are included in the entire surface portion.

As described above, in a case in which the center portion is formed of the first lithium composite metal oxide containing a large amount of the nickel having high capacity characteristics and the surface portion is formed of the second lithium composite metal oxide having a small amount of the nickel and excellent thermal stability on a surface of the center portion, a positive electrode active material having excellent output characteristics, life characteristics, and thermal stability may be provided.

The nickel, cobalt, or manganese included in the center portion and surface portion may be doped with at least one doping element Me. With respect to the positive electrode active material doped with the doping element, the doping element may be uniformly included in the surface and inside of the positive electrode active material, and, as a result, since the structural stability of the positive electrode active material is improved, the life characteristics and thermal stability may be improved.

The doping element Me may be used without particular limitation as long as it may contribute to the improvement of the structural stability of the positive electrode active material, and the doping element Me, for example, may include at least one doping element selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and may preferably include W.

The Me may each independently be included in an amount of greater than 0 mol % to 10 mol % or less, for example, 0.05 mol % or more to 5 mol % or less, based on total moles of the metallic elements except lithium which are included in the entire center portion and surface portion. For example, in a case in which the amounts of the Me in the center portion and surface portion are each independently greater than 10 mol %, a lithium by-product may be increased.

Oxygen (O₂) included in the center portion and surface portion may be substituted with at least one anion A. With respect to the positive electrode active material substituted with the anion, since the anions may be uniformly included in the surface and inside of the positive electrode active material, a secondary battery prepared on the basis thereof may exhibit excellent output characteristics and life characteristics and may have high charge and discharge efficiency.

That is, since the specific anions uniformly included in the surface and inside of the positive electrode active material contribute to the improvement of ionic conductivity between grains and minimize the grains or grain growth, structural changes during oxygen generation in an activation process may be reduced and a surface area may be increased, and thus, overall performance, such as rate capability, of the battery may be improved.

The A may be used without particular limitation as long as it may contribute to the improvement of the ionic conductivity between the grains, and may include at least one selected from the group consisting of PO₄³⁻, NO₄⁻, CO₃²⁻, BO₃⁻, Cl⁻, Br⁻, I⁻, and F⁻, for example, at least one selected from the group consisting of PO₄³⁻, NO₄⁻, CO₃²⁻, BO₃⁻, and F⁻.

The A may each independently be substituted in an amount of 0.01 mol % or more to 10 mol % or less, for example, 0.05 mol % or more to 5 mol % or less, based on total moles of oxygen included in the entire center portion and surface portion. For example, in a case in which the amounts of the A included in the center portion and surface portion are each independently less than 0.01 mol %, an effect of preventing oxygen desorption may be insignificant, and, in a case in which the amounts of the A included in the center portion and surface portion are each independently greater than 10 mol %, since crystallization of the positive electrode active material is disturbed, it may be difficult to improve performance of the positive electrode active material.

An average particle diameter (D₅₀) of the positive electrode active material may be in a range of 4 μm to 20 μm, for example, 6 μm to 15 μm. For example, in a case in which the average particle diameter of the positive electrode active material is less than 4 μm, since rolling density is low, high energy density may not be achieved, and, in a case in which the average particle diameter of the positive electrode active material is greater than 20 μm, the positive electrode active material may not be rolled to a predetermined thickness or less.

In the present specification, the average particle diameter (D₅₀) may be defined as a particle diameter at a cumulative volume of 50% in a particle diameter distribution curve. The average particle diameter (D₅₀), for example, may be measured by using a laser diffraction method. The laser diffraction method may generally measure a particle diameter ranging from a submicron level to a few mm, and may obtain highly repeatable and high resolution results.

Also, the positive electrode active material may further include a coating layer that is formed on the surface of the positive electrode active material, and the coating layer may include at least one selected from the group consisting of B, Al, hafnium (Hf), Nb, Ta, Mo, silicon (Si), Zn, and Zr.

Since the occurrence of a side reaction may be suppressed by blocking a contact between the positive electrode active material and an electrolyte solution included in the lithium secondary battery with the coating layer, the life characteristics may be improved and, in addition, packing density of the positive electrode active material may be increased.

The coating layer may be formed on the entire surface of the positive electrode active material or may be partially formed on the surface of the positive electrode active material. Specifically, in a case in which the coating layer is partially formed on the surface of the positive electrode active material, the coating layer may be formed on an area corresponding to 20% or more to less than 100% of a total area of the positive electrode active material. In a case in which the area of the coating layer is less than 20%, effects of improving life characteristics and packing density due to the formation of the coating layer may be insignificant.

Also, the coating layer may be formed to have a thickness ratio of 0.001 to 1 with respect to the average particle diameter of the positive electrode active material particle. In a case in which the thickness ratio of the coating layer to the positive electrode active material particle is less than 0.001, the effects of improving life characteristics and packing density due to the formation of the coating layer may be insignificant, and, in a case in which the thickness ratio is greater than 1, battery characteristics may degrade.

A peak may appear in a temperature range of 235° C. or more, particularly 235° C. to 250° C., and more particularly 235° C. to 240° C., when heat flow of the positive electrode active material is measured by differential scanning calorimetry. For example, with respect to the heat flow, an amount of heat released is measured while increasing the temperature of the positive electrode active material at a rate of 10° C./min using a differential scanning calorimeter (DSC). In a case in which the heat flow of the positive electrode active material measured by differential scanning calorimetry satisfies the above range, the thermal stability of the positive electrode active material may be improved.

Furthermore, the grains of the positive electrode active material may have a crystal orientation in a direction perpendicular to a C-axis. In a case in which the grains of the positive electrode active material have the crystal orientation in the direction perpendicular to the C-axis, since mobility of lithium ions included in the positive electrode active material is improved and the structural stability of the active material is increased, initial capacity characteristics, output characteristics, resistance characteristics, and long-term life characteristics may be improved when used in the battery.

For example, the particle of the positive electrode active material has a structure in which at least one layer of an oxygen layer and a metal layer is layered and lithium ions are intercalated between stacks of the oxygen layer and the metal layer, wherein the C-axis denotes a direction perpendicular to the metal layer and the oxygen layer in the layered structure of the positive electrode active material particle.

In addition, in a case in which the positive electrode active material has a crystal orientation in one direction, intercalation and deintercalation of the lithium ions in the layer-structured positive electrode active material are facilitated during charge and discharge, and, accordingly, the output characteristics of the lithium secondary battery may be improved.

The positive electrode active material may include a lithium by-product in an amount of less than 1 wt %, but the present invention is not limited thereto. Specifically, the positive electrode active material may include a lithium by-product including LiOH and Li₂CO₃ in an amount of less than 1 wt %. In a case in which 1 wt % or more of the lithium by-product is included in the positive electrode active material, the output characteristics of the lithium secondary battery may be reduced.

A method of preparing a positive electrode active material according to an embodiment of the present invention includes the steps of: preparing a first metal-containing solution including nickel, cobalt, manganese, and doping element Me (where Me includes at least one selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo) and a second metal-containing solution including nickel, cobalt, manganese, and doping element Me in concentrations different from those in the first metal-containing solution (step 1); preparing a positive electrode active material precursor having a concentration gradient, in which concentrations of the nickel and the manganese each independently are gradually changed from a center of a particle to a surface thereof, by mixing the first metal-containing solution and the second metal-containing solution such that a mixing ratio of the first metal-containing solution and the second metal-containing solution is gradually changed from 100 vol %:0 vol % to 0 vol %:100 vol % and adding an ammonium cationic complexing agent and an anion-containing basic compound (step 2); synthesizing a positive electrode active material by mixing and sintering the positive electrode active material precursor and a lithium-containing raw material (step 3); and performing a heat treatment on the positive electrode active material at a temperature of 600° C. to 800° C. in an oxygen atmosphere (step 4).

All the contents described in the above-described positive electrode active material may be applied to the method of preparing a positive electrode active material.

First, a first metal-containing solution including nickel, cobalt, manganese, and doping element Me (where Me includes at least one selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo) and a second metal-containing solution including nickel, cobalt, manganese, and doping element Me in concentrations different from those in the first metal-containing solution are prepared (step 1).

The first metal-containing solution may be prepared by adding a nickel raw material, a cobalt raw material, a manganese raw material, and a raw material of Me to a solvent, specifically, water or a mixture of water and an organic solvent (alcohol etc.) which may be uniformly mixed with the water, or an aqueous solution including each metal-containing raw material is prepared and the aqueous solutions are mixed and used as the first metal-containing solution. In this case, during the preparation of the first metal-containing solution, each of the metal raw materials is mixed such that the nickel is included in an amount of 80 mol % or more to less than 100 mol % based on a total amount of moles of nickel, cobalt, manganese, and doping element Me.

The second metal-containing solution includes a nickel raw material, a cobalt raw material, a manganese raw material, and a raw material of doping element Me, and may be prepared in the same manner as the first metal-containing solution. In this case, during the preparation of the second metal-containing solution, each of the metal raw materials is mixed such that the nickel is included in an amount of 10 mol % or more to less than 80 mol % based on a total amount of moles of nickel, cobalt, manganese, and doping element Me.

As the raw materials of nickel, cobalt, manganese, and doping element Me, each metallic element-containing sulfate, nitrate, acetate, halide, hydroxide, or oxyhydroxide may be used and may be used without particular limitation as long as it may be dissolved in the above-described solvent such as water.

Specifically, the cobalt raw material may include Co(OH)₂, CoOOH, CoSO₄, Co(OCOCH₃)₂.4H₂O, Co(NO₃)₂.6H₂O, or Co(SO₄)₂.7H₂O, and a mixture of one or more thereof may be used.

Also, the nickel raw material may include Ni(OH)₂, NiO, NiOOH, NiCO₃.2Ni(OH)₂.4H₂O, NiC₂O₂.2H₂O, Ni(NO₃)₂.6H₂O, NiSO₄, NiSO₄.6H₂O, a fatty acid nickel salt, or a nickel halide, and a mixture of one or more thereof may be used.

Furthermore, the manganese raw material may include a manganese oxide such as Mn₂O₃, MnO₂, and Mn₃O₄; a manganese salt such as MnCO₃, Mn(NO₃)₂, MnSO₄, manganese acetic acid, manganese dicarboxylate, manganese citrate, and a fatty acid manganese salt; an oxyhydroxide, and manganese chloride, and a mixture of one or more thereof may be used.

Subsequently, a positive electrode active material precursor having a concentration gradient, in which concentrations of the nickel and the manganese each independently are gradually changed from a center of a particle to a surface thereof, is prepared by a co-precipitation reaction by mixing the first metal-containing solution and the second metal-containing solution such that a mixing ratio of the first metal-containing solution and the second metal-containing solution is gradually changed from 100 vol %:0 vol % to 0 vol %:100 vol % and simultaneously adding an ammonium cationic complexing agent and an anion-containing basic compound (step 2).

At the beginning of the step of preparing a positive electrode active material precursor, since the reaction (particle nucleation and particle growth) is performed in a state in which the first metal-containing solution is only present, the precursor particle first prepared has a composition of the first metal-containing solution. Thereafter, since the second metal-containing solution is gradually mixed with the first metal-containing solution, the composition of the precursor particle is gradually changed to a composition of the second metal-containing solution from the center of the precursor particle to an outward direction. For example, the first metal-containing solution may allow to have a high nickel content and a low manganese content, and the second metal-containing solution may allow to have a lower nickel content and a higher manganese content than the first metal-containing solution. When the first metal-containing solution and the second metal-containing solution are reacted, a precursor particle may be prepared in which the concentration of the nickel is decreased while the nickel has a continuous concentration gradient from the center of the particle to the surface thereof, the concentration of the manganese is increased while the manganese has a continuous concentration gradient from the center of the particle to the surface thereof, and the concentration of the cobalt is constantly maintained from the center of the particle to the surface thereof.

Thus, since the concentrations of the first metal-containing solution and the second metal-containing solution are adjusted and their mixing rate and ratio are adjusted, concentration gradients and slopes of the metallic elements in the precursor may be adjusted so that a desired composition is obtained at a desired position from the center of the precursor particle to a surface direction.

Also, the mixing of the first metal-containing solution and the second metal-containing solution is continuously performed, and, since the second metal-containing solution is continuously provided and reacted, precipitates having a concentration gradient, in which the concentration of the metal is continuous from the center of the particle to the surface thereof, may be obtained by a single co-precipitation reaction process. The concentration gradient and slope of the metal in the active material precursor formed in this case may be easily adjusted by the compositions and mixed feed rate of the first metal-containing solution and the second metal-containing solution.

Furthermore, the concentration gradient of the metallic element in the particle may be formed by controlling reaction rate or reaction time. The reaction time may be increased and the reaction rate may be reduced to create a high density state in which the concentration of the specific metal is high, and the reaction time may be reduced and the reaction rate may be increased to create a low density state in which the concentration of the specific metal is low.

The particle diameter and the surface thickness of the positive electrode active material may be controlled by adjusting a supply amount of the second metal-containing solution with respect to the first metal-containing solution and the reaction time. Specifically, the supply amount of the second metal-containing solution and the reaction time may be appropriately adjusted to obtain the positive electrode active material particle diameter as described above.

The ammonium cationic complexing agent may include NH₄OH, (NH₄)₂SO₄, NH₄NO₃, NH₄Cl, CH₃COONH₄, or NH₄CO₃, and a mixture of one or more thereof may be used. Also, the ammonium cationic complexing agent may be used in the form of an aqueous solution, and, in this case, water or a mixture of water and an organic solvent (specifically, alcohol etc.), which may be uniformly mixed with the water, may be used as a solvent.

The ammonium cationic complexing agent may be added in an amount such that a molar ratio of the ammonium cationic complexing agent to 1 mole of a mixed solution, in which the first metal-containing solution and the second metal-containing solution are mixed, becomes 0.5 to 1. In general, an ammonium cationic complexing agent reacts with metal at a molar ratio equal to or greater than 1:1 to form a complex, but, since an unreacted complex, which does not react with a basic aqueous solution, among the formed complex may be changed into an intermediate product to be recovered and reused as the ammonium cationic complexing agent, the amount of the ammonium cationic complexing agent used may be reduced in the present invention, in comparison to a conventional case. As a result, crystallinity of the positive electrode active material may be increased and stabilized.

The anion-containing basic compound may include at least one anion selected from the group consisting of PO₄³⁻, NO₄⁻, CO₃²⁻, BO₃⁻, Cl⁻, Br⁻, I⁻, and F⁻, for example, at least one anion selected from the group consisting of PO₄³⁻, NO₄⁻, CO₃²⁻, BO₃⁻, and F⁻, and the anion may be in a state of being dissolved in a basic substance.

The basic substance included in the anion-containing basic compound may be a hydroxide of alkali metal or alkaline earth metal, such as NaOH, KOH, or Ca(OH)₂, or a hydrate thereof, and a mixture of one or more thereof may be used. The anion-containing basic compound may also be used in the form of an aqueous solution, and, in this case, water or a mixture of water and an organic solvent (specifically, alcohol etc.), which may be uniformly mixed with the water, may be used as a solvent. In this case, a concentration of the anion-containing basic aqueous solution may be in a range of 2 M to 10 M, for example, 2 M to 8 M. In a case in which the concentration of the anion-containing basic aqueous solution is less than 2 M, particle formation time may be increased, tap density may be reduced, and yield of co-precipitation reaction product may be reduced. In a case in which the concentration of the anion-containing basic aqueous solution is greater than 10 M, since the particle rapidly grows due to the rapid reaction, it may be difficult to form uniform particles and the tap density may also be reduced.

Since the anion-containing basic compound is added to the mixed solution in which the first metal-containing solution and the second metal-containing solution are mixed, the anions included in the anion-containing basic compound may be substituted at oxygen sites of the compounds represented by Formula 1 and Formula 2. The desorption of oxygen may be prevented in charge and discharge processes of the lithium secondary battery including the positive electrode active material by substituting the anions at the oxygen sites.

Also, the co-precipitation reaction may be performed under a condition in which a pH of the mixed solution of the first metal-containing solution and the second metal-containing solution is in a range of pH 10 to pH 13, for example, pH 10 to pH 12. When the co-precipitation reaction is performed with the above range, precursor particles may be prepared without changes in diameter of the prepared precursor, occurrence of particle breakage, or formation of various oxides by a side reaction due to elution of metal ions on the surface of the precursor. Accordingly, in order to satisfy the above-described pH range, the ammonium cationic complexing agent and the anion-containing basic compound may be used at a molar ratio of 1:10 to 1:2.

Also, the co-precipitation reaction may be performed in a temperature range of 40° C. to 70° C. in an inert atmosphere such as nitrogen or argon. Furthermore, a stirring process may be selectively performed to increase the reaction rate during the reaction, and, in this case, a stirring speed may be in a range of 100 rpm to 2,000 rpm.

Subsequently, a positive electrode active material is synthesized by mixing and sintering the positive electrode active material precursor and a lithium-containing raw material (step 3).

Any lithium-containing raw material may be used without particular limitation as long as it is commonly used, for example, a lithium-containing sulfate, nitrate, acetate, carbonate, oxalate, citrate, halide, hydroxide, or oxyhydroxide may be used, and the lithium-containing raw material is not particularly limited as long as it may be dissolved in water. Specifically, a mixture of at least one selected from the group consisting of Li₂CO₃, LiNO₃, LiNO₂, LiOH, LiOH.H₂O, LiH, LiF, LiCl, LiBr, LiI, CH₃COOLi, Li₂O, Li₂SO₄, CH₃COOLi, or Li₃C₆H₅O₇ may be used as the lithium-containing raw material.

An amount of the lithium-containing raw material used may be determined according to amounts of the lithium and metal in the finally prepared positive electrode active material, and, specifically, the lithium-containing raw material may be used in an amount such that a molar ratio (molar ratio of lithium/metallic element) of the lithium included in the lithium-containing raw material to the metallic element (Ni, Co, Mn, and Me) included in the precursor is 1.0 or more, for example, 1.03 to 1.20.

The sintering of the positive electrode active material precursor and the lithium-containing raw material may be performed by single-stage or two-stage sintering.

For example, in a case in which the sintering is performed by the single-stage sintering, the single-stage sintering may be performed in a temperature range of 700° C. to 1,000° C., for example, 750° C. to 850° C., for 5 hours to 30 hours, for example, 20 hours to 30 hours. In a case in which the positive electrode active material precursor and the lithium-containing raw material are sintered at 700° C. to 1,000° C., rearrangement of molecules in the active material occurs and, accordingly, the thermal stability of the positive electrode active material may be improved while the molecules are stabilized. In contrast, when the sintering temperature is less than 700° C. and the sintering time is less than 5 hours, there is a concern that discharge capacity per unit weight, cycle characteristics, and operating voltage may be reduced due to residual unreacted raw materials, and, when the sintering temperature is greater than 1,000° C. and the sintering time is greater than 30 hours, there is a concern that the discharge capacity per unit weight, cycle characteristics, and operating voltage may be reduced due to the formation of a side reaction product.

For example, in a case in which the sintering is performed by the two-stage sintering, the two-stage sintering includes first sintering, in which the temperature is increased to 25° C. to 400° C. at a heating rate of 2° C./min to 5° C./min and maintained for 7 hours to 12 hours, and second sintering in which the temperature is increased to 400° C. to 800° C. at a heating rate of 7° C./min to 10° C./min and maintained for 10 hours to 15 hours. For example, the first sintering is performed by increasing the temperature to 350° C. to 400° C. at a heating rate of 4° C./min to 5° C./min and maintaining the temperature for 9 hours to 10 hours, and the second sintering is performed by increasing the temperature to 700° C. to 800° C. at a heating rate of 9° C./min to 10° C./min and maintaining the temperature for 12 hours to 15 hours. In a case in which the positive electrode active material precursor and the lithium-containing raw material are subjected to the two-stage sintering, the grains of the positive electrode active material may have a crystal orientation in the direction perpendicular to the C-axis by decreasing the heating rate, and, accordingly, the mobility of the lithium ions included in the positive electrode active material is improved and the structural stability of the active material is increased. Thus, the initial capacity characteristics, output characteristics, resistance characteristics, and long-term life characteristics may be improved when used in the battery. In contrast, in a case in which the sintering temperatures and heating rates of the first sintering and second sintering of the two-stage sintering are outside the above ranges, there is a concern that the discharge capacity per unit weight, cycle characteristics, and operating voltage may be reduced due to the residual unreacted raw materials.

Also, the sintering may be performed in an oxidizing atmosphere, such as air or oxygen, or a reducing atmosphere including nitrogen or hydrogen. A diffusion reaction between the particles may sufficiently occur and diffusion of the metal may occur in a portion having a constant internal metal concentration through the sintering process under such conditions, and, as a result, a positive electrode active material having a continuous metal concentration distribution from the center to the surface may be prepared.

A sintering agent may be further selectively added during the mixing of the positive electrode active material precursor with the lithium-containing raw material. The sintering agent may specifically be an ammonium ion-containing compound such as NH₄F, NH₄NO₃, or (NH₄)₂SO₄; a metal oxide such as B₂O₃ or Bi₂O₃; or a metal halide such as NiCl₂ or CaCl2, and a mixture of one or more thereof may be used. The sintering agent may be used in an amount of 0.01 mol to 0.2 mol based on 1 mol of the positive electrode active material precursor. If the amount of the sintering agent is excessively low at less than 0.01 mol, an effect of improvement in sintering characteristics of the positive electrode active material precursor may be insignificant, and, if the amount of the sintering agent is excessively high at greater than 0.2 mol, there is a concern that performance of the positive electrode active material may be reduced and initial capacity of the battery may be reduced during charging and discharging due to the excessive amount of the sintering agent.

Furthermore, a water-removing agent may be further selectively added during the mixing of the positive electrode active material precursor with the lithium-containing raw material. Specifically, the water-removing agent may include citric acid, tartaric acid, glycolic acid, or maleic acid, and a mixture of one or more thereof may be used. The water-removing agent may be used in an amount of 0.01 mol to 0.2 mol based on 1 mol of the positive electrode active material precursor.

In addition, a step of washing the synthesized positive electrode active material at a temperature of 15° C. or less may be further included.

The washing may be performed in a temperature range of 15° C. or less, particularly 5° C. to 15° C., and more particularly 5° C. to less than 10° C. Since the lithium by-product and unreacted anions present on the surface of the positive electrode active material may be effectively removed by washing the positive electrode active material within the above temperature range, the life characteristics of the battery may be improved when used in the secondary battery. In contrast, in a case in which the washing temperature is greater than 15° C., the lithium secondary battery may be over-washed, and, in this case, the life and capacity characteristics may be degraded.

Immediately after the synthesis of the positive electrode active material, a lithium by-product including LiOH and Li₂CO₃ may be included in an amount of greater than 1 wt % to 3.0 wt % or less. In this case, the lithium by-product present in the positive electrode active material may be effectively removed by washing the positive electrode active material in a temperature range of 15° C. or less. After the washing, the positive electrode active material may include the lithium by-product including LiOH and Li₂CO₃ in an amount of less than 1 wt %, but the present invention is not limited thereto.

Finally, a heat treatment is performed on the positive electrode active material at 600° C. to 800° C. in an oxygen atmosphere (step 4). Since the heat treatment is performed on the washed positive electrode active material at 600° C. to 800° C., for example, 650° C. to 750° C., for 5 hours to 10 hours, the thermal stability of the positive electrode active material may be improved, the rearrangement of the metallic elements in the positive electrode active material may occur, and the lithium diffusion in the positive electrode active material may proceed to cause recrystallization of the positive electrode active material. Thus, the life characteristics may be further improved.

In addition, after the washing of the positive electrode active material before the performance of the heat treatment, a step of forming a coating layer by coating the washed positive electrode active material with a metal including at least one selected from the group consisting of B, Al, Hf, Nb, Ta, Mo, Si, Zn, and Zr may be further selectively included, if necessary.

Specifically, a method for forming the coating layer on the positive electrode active material may be used without particular limitation as long as it is a method of forming a coating layer on the surface of the active material, and, for example, after the positive electrode active material is surface-treated with a composition, which is prepared by dispersing the metal in a solvent, by using a conventional slurry coating method such as coating, dipping, and spraying, the coating layer may be formed on the surface of the positive electrode active material by performing a heat treatment.

A mixture of at least one selected from the group consisting of water, an alcohol having 1 to 8 carbon atoms, dimethyl sulfoxide (DMSO), N-methylpyrrolidone, acetone, and a combination thereof may be used as the solvent which may disperse the metal for the formation of the coating layer.

Also, the above-described solvent may be included in an amount such that appropriate coating properties may be obtained and the solvent may be easily removed during the subsequent heat treatment.

Subsequently, the heat treatment for the formation of the coating layer may be performed in a temperature range in which the solvent included in the composition may be removed, and may specifically be performed in a temperature range of 200° C. to 700° C., for example, 250° C. to 400° C. In a case in which the heat treatment temperature is less than 200° C., a side reaction may occur due to the residual solvent and battery characteristics may be degraded due to the side reaction. In a case in which the heat treatment temperature is greater than 700° C., a side reaction may occur due to high heat.

According to another embodiment of the present invention, a positive electrode including the above-described positive electrode active material is provided.

In this case, the positive electrode may be prepared by coating a positive electrode collector with a positive electrode material mixture including a positive electrode active material, a binder, a conductive agent, and a solvent.

Since the positive electrode active material is the same as described above, detailed descriptions thereof will be omitted, and the remaining configurations will be only described in detail below.

The positive electrode collector is not particularly limited as long as it has conductivity without causing adverse chemical changes in the battery, and, for example, stainless steel, aluminum, nickel, titanium, fired carbon, or aluminum or stainless steel that is surface-treated with one of carbon, nickel, titanium, silver, or the like may be used.

The positive electrode active material may be included in an amount of 80 wt % to 99 wt % based on a total weight of the positive electrode material mixture.

The binder is a component that assists in the binding between the active material and the conductive agent and in the binding with the current collector, wherein the binder is typically added in an amount of 1 wt % to 30 wt % based on the total weight of the positive electrode material mixture. Examples of the binder may be polyvinylidene fluoride, polyvinyl alcohol, carboxymethylcellulose (CMC), starch, hydroxypropylcellulose, regenerated cellulose, polyvinylpyrrolidone, tetrafluoroethylene, polyethylene, polypropylene, an ethylene-propylene-diene terpolymer (EPDM), a sulfonated EPDM, a styrene-butadiene rubber, a fluoro rubber, various copolymers, and the like.

The conductive agent may be typically added in an amount of 1 wt % to 30 wt % based on the total weight of the positive electrode material mixture.

The conductive agent is not particularly limited as long as it has conductivity without causing adverse chemical changes in the battery, and, for example, a conductive material such as: graphite; a carbon-based material such as carbon black, acetylene black, Ketjen black, channel black, furnace black, lamp black, and thermal black; conductive fibers such as carbon fibers or metal fibers; metal powder such as fluorocarbon powder, aluminum powder, and nickel powder; conductive whiskers such as zinc oxide whiskers and potassium titanate whiskers; conductive metal oxide such as titanium oxide; or polyphenylene derivatives may be used. Specific examples of a commercial conductive agent may be acetylene black-based products (Chevron Chemical Company, Denka black (Denka Singapore Private Limited), or Gulf Oil Company), Ketjen black, ethylene carbonate (EC)-based products (Armak Company), Vulcan XC-72 (Cabot Company), and Super P (Timcal Graphite & Carbon).

The solvent may include an organic solvent, such as N-methyl-2-pyrrolidone (NMP), and may be used in an amount such that desirable viscosity is obtained when the positive electrode active material as well as selectively the binder and the conductive agent is included. For example, the solvent may be included in an amount such that a concentration of the solid content including the positive electrode active material as well as selectively the binder and the conductive agent is in a range of 50 wt % to 95 wt %, for example, 70 wt % to 90 wt %.

According to another embodiment of the present invention, a lithium secondary battery including the positive electrode is provided.

The lithium secondary battery specifically includes a positive electrode, a negative electrode disposed to face the positive electrode, a separator disposed between the positive electrode and the negative electrode, and an electrolyte. Also, the lithium secondary battery may further selectively include a battery container accommodating an electrode assembly of the positive electrode, the negative electrode, and the separator, and a sealing member sealing the battery container.

Since the positive electrode is the same as described above, detailed descriptions thereof will be omitted, and the remaining configurations will be only described in detail below.

The negative electrode, for example, may be prepared by coating a negative electrode collector with a negative electrode material mixture including a negative electrode active material, a binder, a conductive agent, and a solvent.

The negative electrode collector is not particularly limited as long as it has high conductivity without causing adverse chemical changes in the battery, and, for example, copper, stainless steel, aluminum, nickel, titanium, fired carbon, copper or stainless steel that is surface-treated with one of carbon, nickel, titanium, silver, or the like, and an aluminum-cadmium alloy may be used. Also, the negative electrode collector may typically have a thickness of 3 μm to 500 μm, and, similar to the positive electrode collector, microscopic irregularities may be formed on the surface of the collector to improve the adhesion of the negative electrode active material. The negative electrode collector, for example, may be used in various shapes such as that of a film, a sheet, a foil, a net, a porous body, a foam body, a non-woven fabric body, and the like.

The negative electrode active material may include at least one negative electrode active material selected from the group consisting of natural graphite, artificial graphite, a carbonaceous material; a lithium-containing titanium composite oxide (LTO), metals (Me) such as silicon (Si), tin (Sn), lithium (Li), zinc (Zn), magnesium (Mg), cadmium (Cd), cerium (Ce), nickel (Ni), or iron (Fe); alloys composed of the metals (Me); oxides of the metals (Me); and a composite of carbon and the metals (Me).

The negative electrode active material may be included in an amount of 80 wt % to 99 wt % based on a total weight of the negative electrode material mixture.

The binder is a component that assists in the binding between the conductive agent, the active material, and the current collector, wherein the binder is typically added in an amount of 1 wt % to 30 wt % based on the total weight of the negative electrode material mixture. Examples of the binder may be polyvinylidene fluoride (PVDF), polyvinyl alcohol, carboxymethylcellulose (CMC), starch, hydroxypropylcellulose, regenerated cellulose, polyvinylpyrrolidone, tetrafluoroethylene, polyethylene, polypropylene, an ethylene-propylene-diene polymer (EPDM), a sulfonated-EPDM, a styrene-butadiene rubber, a fluoro rubber, various copolymers, and the like.

The conductive agent is a component for further improving conductivity of the negative electrode active material, wherein the conductive agent may be added in an amount of 1 wt % to 20 wt % based on the total weight of the negative electrode material mixture. The conductive agent is not particularly limited as long as it has conductivity without causing adverse chemical changes in the battery, and, for example, a conductive material such as: graphite such as natural graphite or artificial graphite; carbon black such as acetylene black, Ketjen black, channel black, furnace black, lamp black, and thermal black; conductive fibers such as carbon fibers or metal fibers; metal powder such as fluorocarbon powder, aluminum powder, and nickel powder; conductive whiskers such as zinc oxide whiskers and potassium titanate whiskers; conductive metal oxide such as titanium oxide; or polyphenylene derivatives may be used.

The solvent may include water or an organic solvent, such as N-methyl-2-pyrrolidone (NMP), and may be used in an amount such that desirable viscosity is obtained when the negative electrode active material as well as selectively the binder and the conductive agent is included. For example, the solvent may be included in an amount such that a concentration of the solid content including the negative electrode active material as well as selectively the binder and the conductive agent is in a range of 50 wt % to 95 wt %, for example, 70 wt % to 90 wt %.

Also, a typical porous polymer film used as a typical separator, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, may be used alone or in a lamination therewith as the separator. Furthermore, a typical porous nonwoven fabric, for example, a nonwoven fabric formed of high melting point glass fibers or polyethylene terephthalate fibers may be used, but the separator is not limited thereto.

In this case, an organic-inorganic composite separator further coated with an inorganic material for securing heat resistance or mechanical strength may be used, and the separator having a single layer or multilayer structure may be selectively used.

The inorganic material may be used without particular limitation as long as it is a material which may play a role in uniformly controlling pores of the organic-inorganic composite separator and improving heat resistance. For example, non-limiting examples of the inorganic material may be at least one selected from the group consisting of SiO₂, Al₂O₃, TiO₂, BaTiO₃, Li₂O, LiF, LiOH, Li₃N, BaO, Na₂O, Li₂CO₃, CaCO₃, LiAlO₂, SrTiO₃, SnO₂, CeO₂, MgO, NiO, CaO, ZnO, ZrO₂, SiC, derivatives thereof, and a mixture thereof.

An average diameter of the inorganic material may be in a range of 0.001 μm to 10 μm, for example, 0.001 μm to 1 μm. When the average diameter of the inorganic material is within the above range, dispersibility in the coating solution may be improved and the occurrence of problems in a coating process may be minimized. Also, physical properties of the final separator may not only be homogenized, but also inorganic particles may be uniformly distributed on pores of nonwoven fabric to improve mechanical properties of the nonwoven fabric, and a size of pores of the organic-inorganic composite separator may be easily adjusted.

An average diameter of the pores of the organic-inorganic composite separator may be in a range of 0.001 μm to 10 μm, for example, 0.001 μm to 1 μm. When the average diameter of the pore of the organic-inorganic composite separator is within the above range, gas permeability and ion conductivity may not only be controlled to desired ranges, but a possible internal short-circuit of the battery due to the contact between the positive electrode and the negative electrode may also be eliminated when the battery is prepared by using the organic-inorganic composite separator.

A porosity of the organic-inorganic composite separator may be in a range of 30 vol % to 90 vol %. In a case in which the porosity is within the above range, the ion conductivity may be increased and mechanical strength may be improved.

Also, the electrolyte used in the present invention may include an organic liquid electrolyte, an inorganic liquid electrolyte, a solid polymer electrolyte, a gel-type polymer electrolyte, a solid inorganic electrolyte, or a molten-type inorganic electrolyte which may be used in the preparation of the lithium secondary battery, but the present invention is not limited thereto.

Specifically, the electrolyte may include an organic solvent and a lithium salt.

Any organic solvent may be used as the organic solvent without particular limitation so long as it may function as a medium through which ions involved in an electrochemical reaction of the battery may move. Specifically, an ester-based solvent such as methyl acetate, ethyl acetate, γ-butyrolactone, and ε-caprolactone; an ether-based solvent such as dibutyl ether or tetrahydrofuran; a ketone-based solvent such as cyclohexanone; an aromatic hydrocarbon-based solvent such as benzene and fluorobenzene; or a carbonate-based solvent such as dimethyl carbonate (DMC), diethyl carbonate (DEC), methylethyl carbonate (MEC), ethylmethyl carbonate (EMC), ethylene carbonate (EC), and propylene carbonate (PC); an alcohol-based solvent such as ethyl alcohol and isopropyl alcohol; nitriles such as R—CN (where R is a linear, branched, or cyclic C2-C20 hydrocarbon group and may include a double-bond aromatic ring or ether bond); amides such as dimethylformamide; dioxolanes such as 1,3-dioxolane; or sulfolanes may be used as the organic solvent. Among these solvents, the carbonate-based solvent may be used, and, for example, a mixture of a cyclic carbonate (e.g., ethylene carbonate or propylene carbonate) having high ionic conductivity and high dielectric constant, which may increase charge/discharge performance of the battery, and a low-viscosity linear carbonate-based compound (e.g., ethylmethyl carbonate, dimethyl carbonate, or diethyl carbonate) may be used. In this case, the performance of the electrolyte solution may be excellent when the cyclic carbonate and the chain carbonate are mixed in a volume ratio of about 1:1 to about 1:9.

The lithium salt may be used without particular limitation as long as it is a compound capable of providing lithium ions used in the lithium secondary battery. Specifically, LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂ may be used as the lithium salt. The lithium salt may be used in a concentration range of 0.1 M to 2.0 M. In a case in which the concentration of the lithium salt is included within the above range, since the electrolyte may have appropriate conductivity and viscosity, excellent performance of the electrolyte may be obtained and lithium ions may effectively move.

In order to improve lifetime characteristics of the battery, suppress the reduction in battery capacity, and improve discharge capacity of the battery, at least one additive, for example, a halo-alkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further included in the electrolyte in addition to the electrolyte components. In this case, the additive may be included in an amount of 0.1 wt % to 5 wt % based on a total weight of the electrolyte.

As described above, since the lithium secondary battery including the positive electrode active material according to the present invention stably exhibits excellent discharge capacity, output characteristics, and capacity retention, the lithium secondary battery is suitable for portable devices, such as mobile phones, notebook computers, and digital cameras, and electric cars such as hybrid electric vehicles (HEVs).

Thus, according to another embodiment of the present invention, a battery module including the lithium secondary battery as a unit cell and a battery pack including the battery module are provided.

The battery module or the battery pack may be used as a power source of at least one medium and large sized device of a power tool; electric cars including an electric vehicle (EV), a hybrid electric vehicle, and a plug-in hybrid electric vehicle (PHEV); or a power storage system.

A shape of the lithium secondary battery of the present invention is not particularly limited, but a cylindrical type using a can, a prismatic type, a pouch type, or a coin type may be used.

The lithium secondary battery according to the present invention may not only be used in a battery cell that is used as a power source of a small device, but may also be used as a unit cell in a medium and large sized battery module including a plurality of battery cells.

Hereinafter, the present invention will be described in detail, according to specific examples. The invention may, however, be embodied in many different forms and should not be construed as being limited to the embodiments set forth herein. Rather, these example embodiments are provided so that this description will be thorough and complete, and will fully convey the scope of the present invention to those skilled in the art.

### EXAMPLES

### Example 1

[Positive Electrode Active Material Preparation]

In a 5 L batch-type reactor set at 60° C., NiSO₄, CoSO₄, MnSO₄, and Na₂WO₄ were mixed in water in amounts such that a molar ratio of nickel:cobalt:manganese:tungsten was 98.77:0.63:0.57:0.03 to prepare a first metal-containing solution with a concentration of 2M, and NiSO₄, CoSO₄, MnSO₄, and Na₂WO₄ were mixed in water in amounts such that a molar ratio of nickel:cobalt:manganese:tungsten was 69.16:25.97:4.84:0.03 to prepare a second metal-containing solution with a concentration of 2M.

A container containing the first metal-containing solution and a container containing the second metal-containing solution were respectively connected to an in-line static mixer, and the reactor was connected to an outlet side of the static mixer. In addition, a 4M NaOH solution having 1 mol % Na₃PO₄ added thereto and a 7% NH₄OH aqueous solution were prepared and connected to the reactor, respectively. 3 L of deionized water was put in a co-precipitation reactor (capacity 5 L), the reactor was then purged with nitrogen gas at a rate of 2 L/min to remove dissolved oxygen in the water and create a non-oxidizing atmosphere in the reactor. Thereafter, 100 ml of 4M NaOH containing 1 mol % Na₃PO₄ was added, and stirring was then performed at a speed of 1,100 rpm and a temperature of 60° C. to maintain a pH at 11.2.

Subsequently, the first metal-containing solution and the second metal-containing solution were mixed while changing a ratio of the first metal-containing solution and the second metal-containing solution from 100 vol %:0 vol % to 0 vol %:100 vol %. The resulting mixed metal solution was allowed to be continuously added to the reactor at a rate of 5 m/s through a pipe for a mixed solution, and the NaOH aqueous solution containing 1 mol % Na₃PO₄ and the NH₄OH aqueous solution were respectively added at rates of 180 mL/hr and 10 mL/hr and subjected to a co-precipitation reaction for 24 hours to precipitate particles of a nickel manganese cobalt tungsten-based composite metal hydroxide. The precipitated nickel manganese cobalt tungsten-based composite metal hydroxide particles were separated and washed, and a precursor for a positive electrode active material was then prepared by drying the hydroxide particles in an oven at 120° C. for 24 hours.

After the precursor thus obtained was dry-mixed with Li₂CO₃ (1.07 mol of the lithium carbonate with respect to 1 mol of the precursor), a heat treatment was performed at 750° C. for 27 hours in an oxygen atmosphere to prepare a positive electrode active material having a concentration gradient of metallic elements in an active material particle.

Specifically, a positive electrode active material including a center portion having an average composition represented by Li_{1.03}Ni_{0.9124}Co_{0.0722}Mn_{0.0104}W_{0.005}O_{1.9955} (PO₄)_{0.0045} and a surface portion having an average composition represented by Li_{1.03}Ni_{0.7626}Co_{0.1046}Mn_{0.1278}W_{0.005} (O₂)_{0.99775} (PO₄)_{0.0045} was prepared by the above-described method.

Subsequently, the positive electrode active material thus prepared was washed at 9° C., and dried at 130° C. for 10 hours after the washing.

A surface of the washed positive electrode active material was dry-coated with a boronic acid at 300° C. for 5 hours to coat the surface with boron, and the positive electrode active material was then heat-treated at 700° C. for 5 hours in an oxygen atmosphere.

[Positive Electrode Preparation]

Based on 100 parts by weight of N-methyl-2-pyrrolidone (NMP) as a solvent, the positive electrode active material, a carbon black conductive agent, and a polyvinylidene fluoride (PVDF) binder were mixed at a ratio of 96.5:1.5:2.0 (wt %) to prepare a composition for forming a positive electrode (viscosity: 5,000 mPas), and a 100 μm thick positive electrode collector (Al thin film) was coated with the composition, dried, and roll-pressed to prepared a positive electrode.

[Secondary Battery Preparation]

A coin-type half cell was prepared by a conventional method in which, after a porous polyethylene separator was disposed between the positive electrode prepared by the above-described method and a Li metal as a counter electrode, an electrolyte, in which 1M lithium hexafluorophosphate (LiPF₆) was dissolved in an organic solvent composed of ethylene carbonate/dimethyl carbonate (volume ratio of 1:1), was injected thereinto.

### Example 2

A positive electrode active material, a positive electrode, and a secondary battery including the positive electrode were prepared in the same manner as in Example 1 except that, after the positive electrode active material precursor prepared in Example 1 was dry-mixed with Li₂CO₃ (1.07 mol of the lithium carbonate with respect to 1 mol of the precursor), first sintering was performed by increasing the temperature to 400° C. at a heating rate of 5° C./min in an oxygen atmosphere and maintaining the temperature for 10 hours, and, subsequently, second sintering was performed by increasing the temperature to 780° C. at a heating rate of 10° C./min and maintaining the temperature for 12 hours to prepare the positive electrode active material.

### COMPARATIVE EXAMPLES

### Comparative Example 1

A positive electrode and a secondary battery including the same were prepared by using a positive electrode active material represented by Li(Ni_{0.88}Mn_{0.09}Co_{0.03}) (O₂) as a positive electrode active material. In this case, methods of preparing the positive electrode and secondary battery were the same as described in Example 1.

### Comparative Example 2

In a 5 L batch-type reactor set at 60° C., NiSO₄, CoSO₄, MnSO₄, and Na₂WO₄ were mixed in water in amounts such that a molar ratio of nickel:cobalt:manganese:tungsten was 98.77:0.63:0.57:0.03 to prepare a first metal-containing solution with a concentration of 2M, and NiSO₄, CoSO₄, MnSO₄, and Na₂WO₄ were mixed in water in amounts such that a molar ratio of nickel:cobalt:manganese:tungsten was 69.16:25.97:4.84:0.03 to prepare a second metal-containing solution with a concentration of 2M.

A container containing the first metal-containing solution and a container containing the second metal-containing solution were respectively connected to a co-precipitation reactor. In addition, a 4M NaOH solution having 1 mol % Na₃PO₄ added thereto and a 7% NH₄OH aqueous solution were prepared and connected to the reactor, respectively. 3 L of deionized water was put in a co-precipitation reactor (capacity 5 L), the reactor was then purged with nitrogen gas at a rate of 2 L/min to remove dissolved oxygen in the water and create a non-oxidizing atmosphere in the reactor. Thereafter, 100 ml of 4M NaOH containing 1 mol % Na₃PO₄ was added, and stirring was then performed at a speed of 1,100 rpm and a temperature of 60° C. to maintain a pH at 11.2.

The first metal-containing solution, the NaOH solution, and the NH₄OH aqueous solution were respectively added to the co-precipitation reactor at rates of 5 m/s, 180 mL/hr, and 10 mL/hr and reacted for 12 hours to form a center portion of a positive electrode active material.

Subsequently, the second metal-containing solution, the NaOH solution, and the NH₄OH aqueous solution were added to the reactor at the same rate and reacted for 12 hours to form a positive electrode active material precursor in which a surface portion was formed on a surface of the center portion. A positive electrode and a secondary battery including the same were prepared in the same manner as in Example 1 except that the above-described precursor was used.

### Comparative Example 3

A positive electrode active material, a positive electrode, and a secondary battery including the positive electrode were prepared in the same manner as in Example 1 except that the prepared positive electrode active material was not heat-treated in an oxygen atmosphere.

### EXPERIMENTAL EXAMPLES

### Experimental Example 1: Thermal Stability Evaluation

Thermal stabilities were evaluated for the positive electrode active materials prepared in Examples 1 and 2 and Comparative Examples 2 and 3.

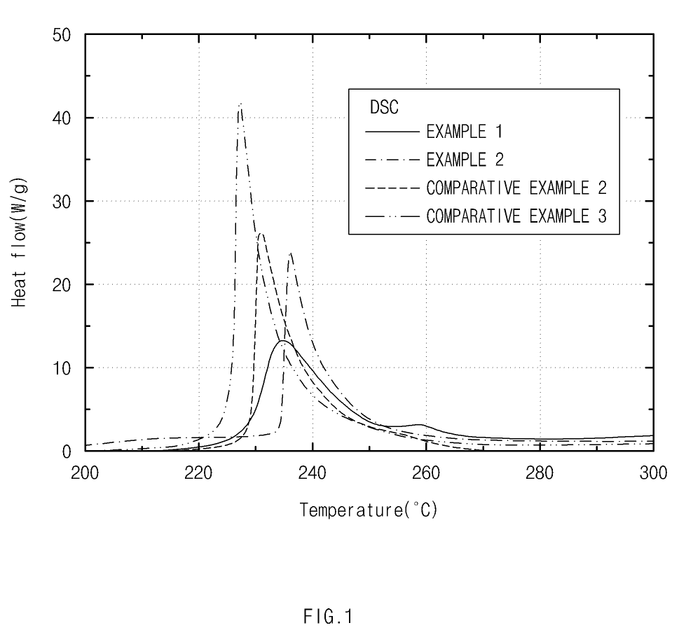

Specifically, heat flows of the positive electrode active materials prepared in Examples 1 and 2 and Comparative Examples 2 and 3 were respectively measured while increasing the temperature at a rate of 10° C./min using a differential scanning calorimeter (DSC), and the results thereof are presented in FIG. 1.

As illustrated in FIG. 1, with respect to the positive electrode active materials of Examples 1 and 2, it may be confirmed that heat flow peaks appeared at higher temperatures and heights of the heat flow peaks were lower than the positive electrode active material prepared in Comparative Example 3. Thus, it may be confirmed that thermal stabilities of the positive electrode active materials prepared by further heat treating at a high temperature after the synthesis of the positive electrode active materials as in Examples 1 and 2 were better than that of the positive electrode active material prepared without an additional heat treatment in an oxygen atmosphere after the synthesis as in Comparative Example 3. Also, since the positive electrode active materials prepared in Examples 1 and 2 of the present invention had a concentration gradient from the center of the particle to the surface thereof, an abrupt phase boundary region was not present throughout the entire particle. Thus, its crystal structure was stabilized and, accordingly, the thermal stabilities were further increased in comparison to Comparative Example 2 which did not have a concentration gradient.

### Experimental Example 2: Synthesized Positive Electrode Active Material Analysis

Crystal orientations of the positive electrode active materials prepared in Example 2 and Comparative Example 2 were confirmed by using a scanning electron microscope.

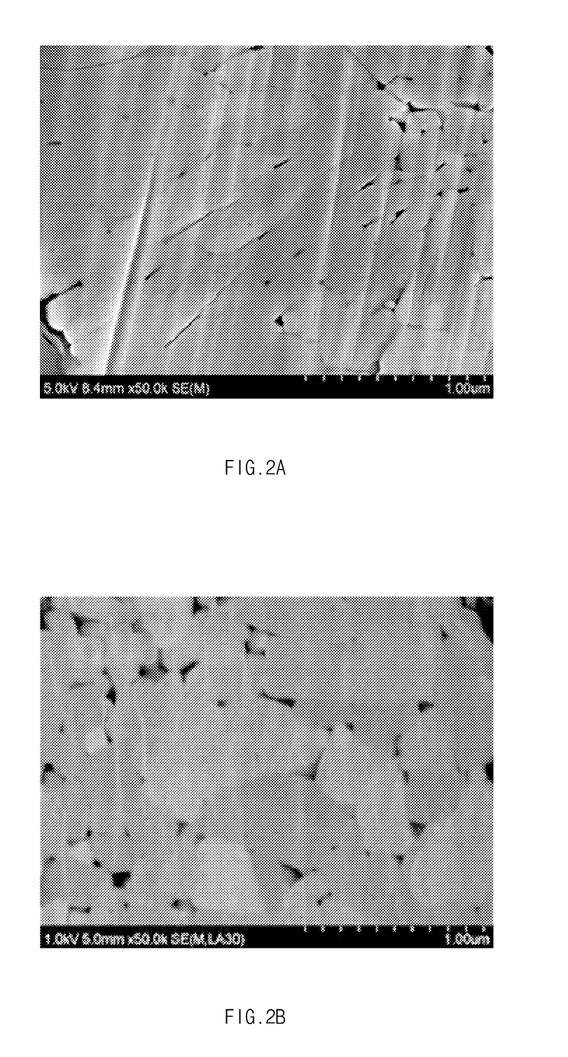

As a result of the confirmation, it may be confirmed that grains of the positive electrode active material prepared in Example 2 had a crystal orientation in a direction perpendicular to the C-axis as illustrated in FIG. 2A, but the positive electrode active material prepared by the single-stage sintering of Comparative Example 2 did not have a specific orientation as illustrated in FIG. 2B.

That is, in a case in which the positive electrode active material precursor and Li₂CO₃ were sintered in two stages, it may be confirmed that a positive electrode active material having a crystal orientation in a specific direction may be achieved.

### Experimental Example 3: Cycle Life Evaluation

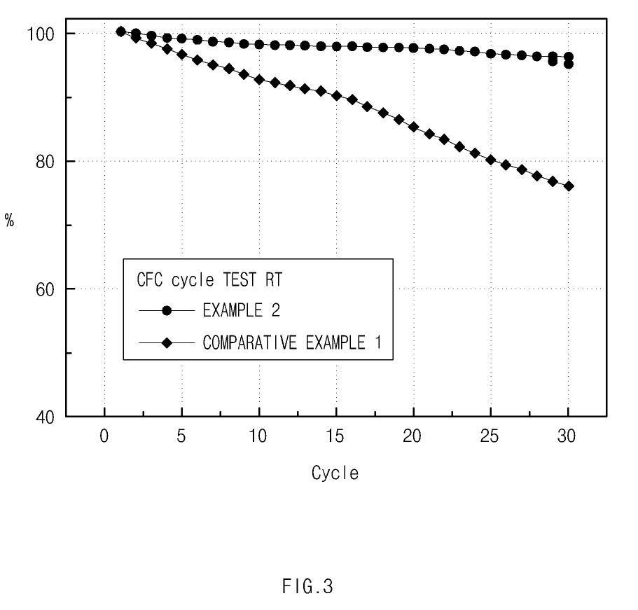

Cycle life evaluation was performed on the lithium secondary batteries prepared in Example 2 and Comparative Example 1, and the results thereof are presented in FIG. 3.

Specifically, the lithium secondary batteries with a capacity of 5 mAh prepared in Example 2 and Comparative Example 1 were charged at a constant current of 0.3 C to a voltage of 4.25 V at 25° C., and thereafter, charging was terminated when the charge current was 0.25 mA by charging the batteries at a constant voltage of 4.25 V. After the batteries were left standing for 10 minutes, the batteries were discharged at a constant current of 0.3 C to a voltage of 2.5 V. The above charge/discharge behavior was set as one cycle, and capacity retentions after this cycle was repeated 30 times were measured.

As illustrated in FIG. 3, with respect to the lithium secondary battery of Example 2, a capacity retention of about 95% was obtained when the cycle was repeated 30 times, but the lithium secondary battery of Comparative Example 1, in which Li(Ni_{0.88}Mn_{0.09}Co_{0.03})O₂, which had the same composition through the particle, did not have a concentration gradient, and was not subjected to anion substitution, was used as a positive electrode active material, had a capacity retention of less than 80%, and thus, the lithium secondary battery of Example 2 had better cycle characteristics than the lithium secondary battery of Comparative Example 1.

### Experimental Example 4: Resistance Characteristic Evaluation

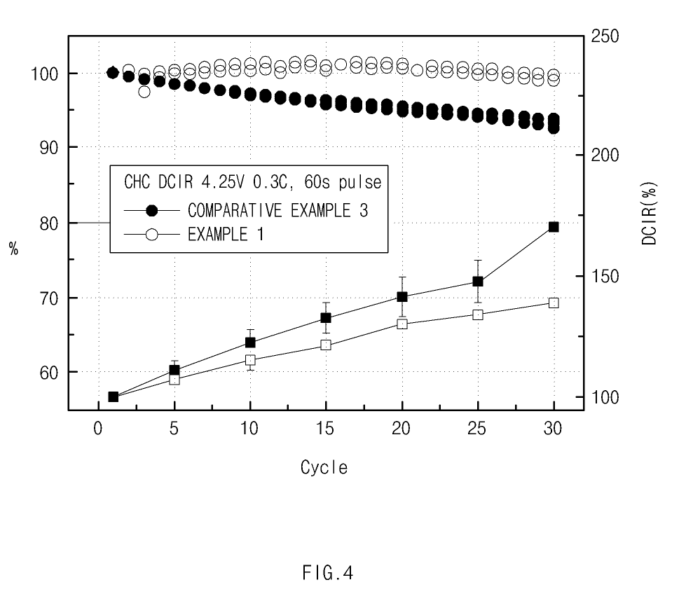

Resistance characteristic and life characteristic were evaluated on the lithium secondary batteries prepared in Example 1 and Comparative Example 3, and the results thereof are presented in FIG. 4.

Specifically, the lithium secondary batteries with a capacity of 5 mAh prepared in Example 1 and Comparative Example 3 were charged at a constant current of 0.3 C to a voltage of 4.25 V at 25° C., and, after the batteries were left standing for 10 minutes, the batteries were discharged at a constant current of 0.3 C to a voltage of 2.5 V.

First, the above charge/discharge behavior was set as one cycle, and capacity retentions after this cycle was repeated 30 times were measured. As illustrated in FIG. 4, the lithium secondary battery prepared in Example 1 had a capacity retention of 95% or more when the cycle was repeated 30 times. However, the lithium secondary battery of Comparative Example 3, which was prepared in the same manner as in Example 1 but was not subjected to an additional heat treatment with oxygen after the preparation of the active material, had a capacity retention of less than 95% when the cycle was repeated 30 times.

Subsequently, after the batteries were charged and discharged in the same manner as in the measurement of the capacity retention, the charge/discharge behavior was set as one cycle, and, after this cycle was repeated 30 times, a resistance increase rate was measured based on resistance measured during the first discharge.

As illustrated in FIG. 4, with respect to the lithium secondary battery of Example 1, the resistance increase rate was improved in comparison to the lithium secondary battery of Comparative Example 3 when the cycle was repeated 30 times.

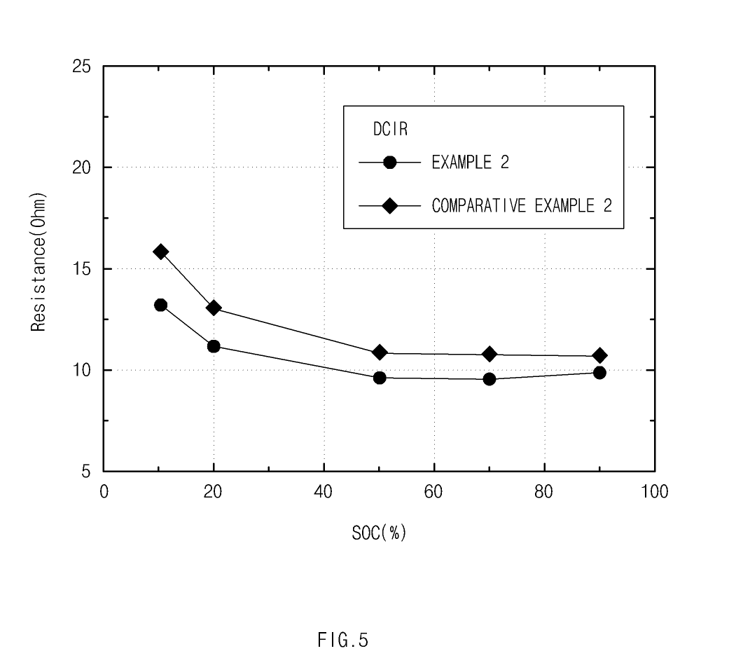

Resistances at 20%, 40%, 60%, 80%, and 100% state of charge (SOC) were respectively measured for the lithium secondary batteries prepared in Example 2 and Comparative Example 2. Specifically, the lithium secondary batteries with a capacity of 5 mAh prepared in Example 2 and Comparative Example 2 were charged at a constant current of 0.3 C to a voltage of 4.25 V at 25° C., thereafter, the batteries were discharged at a constant current of 0.3 C to a voltage of 2.5 V, and resistance for each SOC was measured. The results of measurement of the resistance for each SOC are presented in FIG. 5.

Referring to FIG. 5, with respect to the lithium secondary battery prepared in Example 2, resistance was the lowest in an entire SOC range. Since the positive electrode active material of Example 2 not only had a concentration gradient, in which the concentrations of nickel and manganese were gradually changed from the center of the particle to the surface thereof, but also had a crystal orientation, structural stability of the active material was excellent and mobility of lithium ions included in the active material was improved. Thus, the resistance was lower than that of the lithium secondary battery in which the active material of Comparative Example 2, which did not have a concentration gradient and a crystal orientation, was used.

### Experimental Example 5: Cycle Life Evaluation at 4.5 V

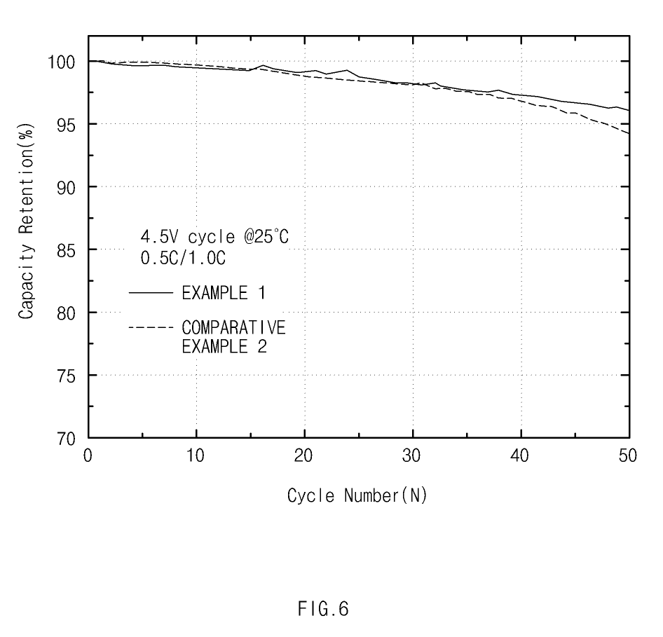

Cycle life evaluation at a high voltage (4.5 V) was performed on the lithium secondary batteries prepared in Example 1 and Comparative Example 2, and the results thereof are presented in FIG. 6.

Specifically, the lithium secondary batteries with a capacity of 5 mAh prepared in Example 1 and Comparative Example 2 were charged at a constant current of 0.5 C to a voltage of 4.5 V at 25° C., and, after the batteries were left standing for 10 minutes, the batteries were discharged at a constant current of 0.1 C to a voltage of 2.5 V. The above charge/discharge behavior was set as one cycle, and, after this cycle was repeated 50 times, capacity retentions of the batteries after the 50 cycles were measured.

As illustrated in FIG. 6, it may be confirmed that the lithium secondary battery prepared in Example 1 had an excellent capacity retention of 95% or more even after the battery was charged and discharged 50 times at 4.5 V. In contrast, with respect to the lithium secondary battery prepared in Comparative Example 2, it may be confirmed that the capacity retention, after the battery was charged and discharged 50 times at 4.5 V, was lower than that of Example 1.

1. A positive electrode active material having a concentration gradient in which concentrations of nickel and manganese are gradually changed from a center of a particle to a surface thereof,
wherein the positive electrode active material comprises a center portion including a first lithium composite metal oxide having an average composition represented by Formula 1; and a surface portion including a second lithium composite metal oxide having an average composition represented by Formula 2, and
a peak appears at 235° C. or more when heat flow of the positive electrode active material is measured by differential scanning calorimetry:
Li₁₊ₓ₁(Niₐ₁Mn_{b1}Co_{1-a1-b1-c1}Me_{c1})O_{2-y1}A_{y1} [Formula 1]
Li₁₊ₓ₂(Niₐ₂Mn_{b2}Co_{1-a2-b2-c2}Me_{c2})O_{2-y2}A_{y2} [Formula 2]
wherein, in Formula 1 and 2,
Me is at least one doping element selected from the group consisting of tungsten (W), copper (Cu), iron (Fe), vanadium (V), chromium (Cr), titanium (Ti), zirconium (Zr), zinc (Zn), aluminum (Al), indium (In), tantalum (Ta), yttrium (Y), lanthanum (La), strontium (Sr), gallium (Ga), scandium (Sc), gadolinium (Gd), samarium (Sm), calcium (Ca), cerium (Ce), niobium (Nb), magnesium (Mg), boron (B), and molybdenum (Mo),
A is at least one anion selected from the group consisting of PO₄³⁻, NO₄⁻, CO₃²⁻, BO₃⁻, Cl⁻, Br⁻, I⁻, and F⁻,
0.8≤a1<1, 0<b1<0.2, 0<c1≤0.1, 0.8<a1+b1+c1<1, 0≤x1≤0.1, 0.0001<y1≤0.1,
0.1≤a2<0.8, 0.1<b2<0.9, 0<c2≤0.1, 0.2<a2+b2+c2<1, 0≤x2≤0.1, and 0.0001<y2≤0.1.

2. The positive electrode active material of claim 1, wherein, in Formula 1 and 2,
A is at least one anion selected from the group consisting of PO₄³⁻, NO₄⁻, CO₃²⁻, BO₃⁻, and F⁻.

3. The positive electrode active material of claim 1, wherein grains of the positive electrode active material have a crystal orientation in a direction perpendicular to a C-axis.

4. The positive electrode active material of claim 1, wherein the positive electrode active material comprises a lithium by-product in an amount of less than 1 wt %.

5. The positive electrode active material of claim 1, further comprising a coating layer including at least one selected from the group consisting of B, Al, hafnium (Hf), Nb, Ta, Mo, silicon (Si), Zn, and Zr on the positive electrode active material.

6. The positive electrode active material of claim 1, wherein the positive electrode active material has an average particle diameter (D₅₀) of 4 μm to 20 μm.

7. A method of preparing a positive electrode active material, the method comprising:
preparing a first metal-containing solution including nickel, cobalt, manganese, and doping element Me (where Me includes at least one selected from the group consisting of tungsten (W), copper (Cu), iron (Fe), vanadium (V), chromium (Cr), titanium (Ti), zirconium (Zr), zinc (Zn), aluminum (Al), indium (In), tantalum (Ta), yttrium (Y), lanthanum (La), strontium (Sr), gallium (Ga), scandium (Sc), gadolinium (Gd), samarium (Sm), calcium (Ca), cerium (Ce), niobium (Nb), magnesium (Mg), boron (B), and molybdenum (Mo)) and a second metal-containing solution including nickel, cobalt, manganese, and doping element Me in concentrations different from those in the first metal-containing solution;
preparing a positive electrode active material precursor having a concentration gradient, in which concentrations of the nickel and the manganese each independently are gradually changed from a center of a particle to a surface thereof, by mixing the first metal-containing solution and the second metal-containing solution such that a mixing ratio of the first metal-containing solution and the second metal-containing solution is gradually changed from 100 vol %:0 vol % to 0 vol %:100 vol % and adding an ammonium cationic complexing agent and an anion-containing basic compound;
synthesizing a positive electrode active material by mixing and sintering the positive electrode active material precursor and a lithium-containing raw material; and
performing a heat treatment on the positive electrode active material at a temperature of 600° C. to 800° C. in an oxygen atmosphere.

8. The method of claim 7, wherein the sintering of the positive electrode active material precursor and the lithium-containing raw material is performed by single-stage or two-stage sintering.

9. The method of claim 8, wherein the single-stage sintering is performed in a temperature range of 700° C. to 800° C.

10. The method of claim 8, wherein the two-stage sintering comprises first sintering, in which the temperature is increased to 25° C. to 400° C. at a heating rate of 2° C./min to 5° C./min and maintained; and second sintering in which the temperature is increased to 400° C. to 800° C. at a heating rate of 7° C./min to 10° C./min and maintained.

11. The method of claim 7, further comprising washing the synthesized positive electrode active material at a temperature of 15° C. or less.

12. The method of claim 7, further comprising forming a coating layer including at least one selected from the group consisting of B, Al, hafnium (Hf), Nb, Ta, Mo, silicon (Si), Zn, and Zr on the positive electrode active material.

13. A positive electrode for a lithium secondary battery, the positive electrode comprising the positive electrode active material of claim 1.

14. A lithium secondary battery comprising the positive electrode of claim 13.
